(19) United States
(12) Patent Application Publication
(10) Pub. No.: US 2007/0005852 A1
(43) Pub. Date: Jan. 4, 2007

(54) Graphical verification tool for packet-based interconnect bus

(75) Inventors: Thomas Michael Armstead, Rochester, MN (US); Eldon Gale Nelson, Rochester, MN (US); Paul Emery Schardt, Rochester, MN (US); Corey Virgil Swenson, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/173,286

(22) Filed: Jun. 30, 2005

(51) Int. Cl. G06F 13/00

(52) U.S. Cl. 710/100

(57) ABSTRACT

Methods, apparatus, and articles of manufacture that allow packet-based communication transactions between devices over an interconnect bus to be captured in a standardized format are provided. The standardized format may enable the display of the bus transactions via a graphical user interface (GUI), which may greatly facilitate viewing and analyzing the transactions when validating communications.

### BACKGROUND OF THE INVENTION

1. Field of the Invention

The present invention generally relates to exchanging packets of data on an interconnect bus between two devices and, more particularly, to verifying such communication.

2. Description of the Related Art

A system on a chip (SOC) generally includes one or more integrated processor cores, some type of embedded memory, such as a cache shared between the processors cores, and peripheral interfaces, such as external bus interfaces, on a single chip to form a complete (or nearly complete) system. The external bus interface is often used to pass data in packets over an external bus between these systems and an external device, such as an external memory controller or graphics processing unit (GPU). To increase system performance, the data transfer rates between such devices has been steadily increasing over the years.

Unfortunately, as the data transfer rate between devices increases, bytes of data transferred between devices may become skewed for different reasons, such as internal capacitance, differences in drivers and/or receivers used on the different devices, different routing of internal bus paths, and the like. Such skew may cause data transferred from one device to be read erroneously by the other device. This misalignment can lead to incorrectly assembled data fed into the processor cores, which may have unpredictable results and possibly catastrophic effects.

Therefore, it is generally desirable to verify communications across packet-based interconnect buses by monitoring traffic on the bus. Conventionally, monitored bus traffic is captured during simulated operation on a system under test. During simulation, a bus monitor tracks bus activity with defined bus timing utilizing architected protocol rules to identify and police bus events. Bus events are captured in a simulation log. Error warning messages are posted in the simulation log if any timing or bus-rules are violated.

After the simulation has finished, a user can view all the bus events or signals by looking at the waveforms using a conventional waveform viewer. However, because the trace information contained in the waveforms is rather cryptic, significant effort may be required to manually analyze and decipher meaningful information from the waveforms. As a result, verification of packet-based interconnect buses is typically very time consuming, particularly when trying to decipher complex scenarios, such as the recovery of packet errors using complicated retry protocols implemented in some serial interfaces.

Accordingly, what is needed is improved methods and apparatus for verifying packet-based communication across interconnect buses.

### SUMMARY OF THE INVENTION

Embodiments of the present invention generally provide methods and apparatus for verifying packet-based communication between devices across an interconnect bus.

One embodiment provides a method of validating communications between devices over an interconnect bus. The method generally includes monitoring the interconnect bus to detect bus events, capturing the bus events in a trace log of standardized trace output, parsing the standardized trace output to identify bus transactions, and displaying, to a user, at least some of the identified bus transactions in a graphical user interface.

Another embodiment provides a computer readable medium containing a program for validating communications between devices over an interconnect bus When executed by a processor, the program performs operations generally including parsing standardized trace output containing bus events captured during operation of the devices to identify individual packets exchanged between devices over the bus and displaying, to a user, representations of at least some of the individual packets in a graphical user interface.

Another embodiment provides a system for validating communications between devices across an interconnect bus. The system generally includes a bus monitor, a converter component, and a graphical user interface. The bus monitor is generally configured to monitor traffic across the bus and generating a log of detected bus events. The converter component is generally configured to convert the log of detected bus events to generate standardized trace output. The graphical user interface is generally configured to display graphical representations of packets exchanged between the devices across the interconnect bus extracted from the standardized trace output.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary test environment in accordance with one embodiment of the present invention;

FIG. 2 is a flow diagram of exemplary operations for capturing bus events as standardized trace language and graphically presenting the same;

FIG. 3 is a block diagram that illustrates components that may perform the operations shown in FIG. 2;

FIGS. 4A-4C illustrate exemplary graphical user interface (GUI) screens for presenting packet information; and

FIGS. 5A and 5B illustrate exemplary standardized trace format, illustratively implemented in extensible Markup Language (XML).

### DETAILED DESCRIPTION OF THE PREFERRED EMBODIMENTS

Embodiments of the present invention allow packet-based communication transactions between devices over an interconnect bus to be captured in a standardized format. The standardized format may enable the display of the bus transactions via a graphical user interface (GUI), which may greatly enhance viewing and analyzing the transactions when validating communications. By graphically viewing the transactions and contents thereof, the source of communications problems (e.g., one of the devices communicating over the bus, or the bus itself) may be efficiently debugged.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary Test System

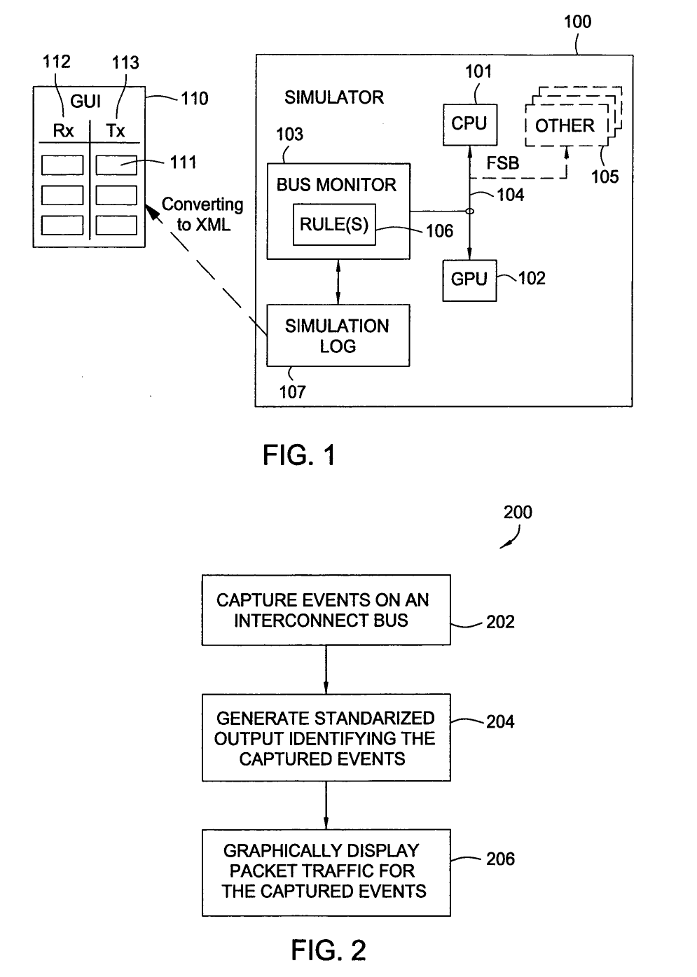

FIG. 1 illustrates an exemplary testing system in which a simulator 100 comprises a CPU 101 and a GPU 102, communicating over an interconnect bus 104 (e.g., commonly referred to as a front side bus). A bus monitor 103 is configured to monitor events on the bus 104 and capture the events in a simulation log 107. For some embodiments, the bus 104 may be a bidirectional multi-bit bus, for example, having eight or more lines for communication from the CPU to the GPU and another eight or more lines for communications from the GPU to the CPU.

For some embodiments any number of other hardware devices 105 (e.g., memory controllers, direct memory access units, I/O controllers, and the like) may also communicate with the CPU and/or GPU over the same interconnect bus 104 or a different bus. While embodiments are described herein with reference to communications between a CPU and GPU, the techniques described herein may be applied in a similar manner to validation communications between various other devices. Further, the devices do not need to be on the same bus and the techniques described herein may be generally applied to associate packets between any traceable interface (e.g., including interrupt lines).

The bus monitor 103 generally includes any suitable combination of hardware and software configured to detect bus events. For example, the bus monitor 103 may include hardware configured to sample data signal lines in conjunction with a clock signal. Driver software may be configured to gather sampled data and apply a set of protocol/timing rules 106 to detect and police bus events. For example, one rule may define the timing of a start bit indicating the beginning of a packet. The driver software may store detected bus events, including errors detected due to violation of rules 106, in a simulation log 107. The simulation log 107 may be any suitable format, such as a binary file or a text file viewable through a text editor or a waveform viewer.

### Standardize Trace Output

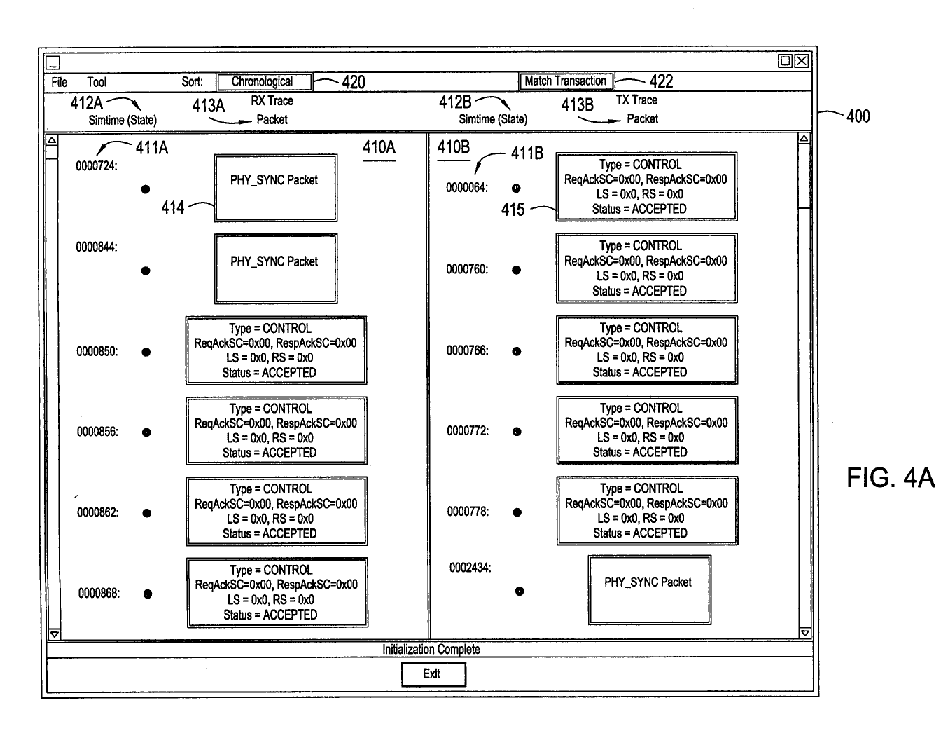

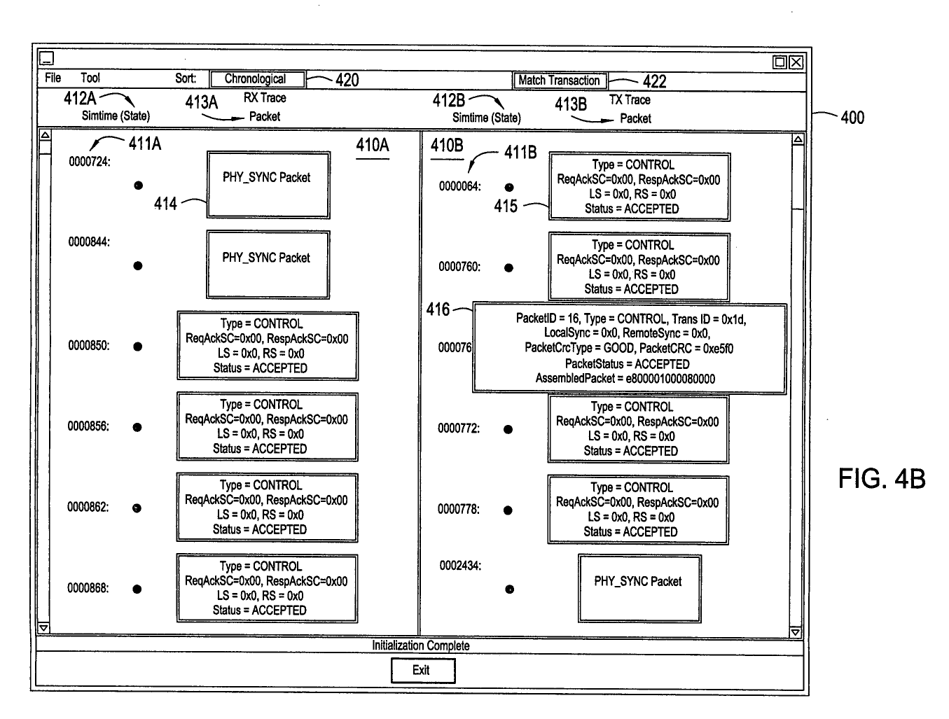

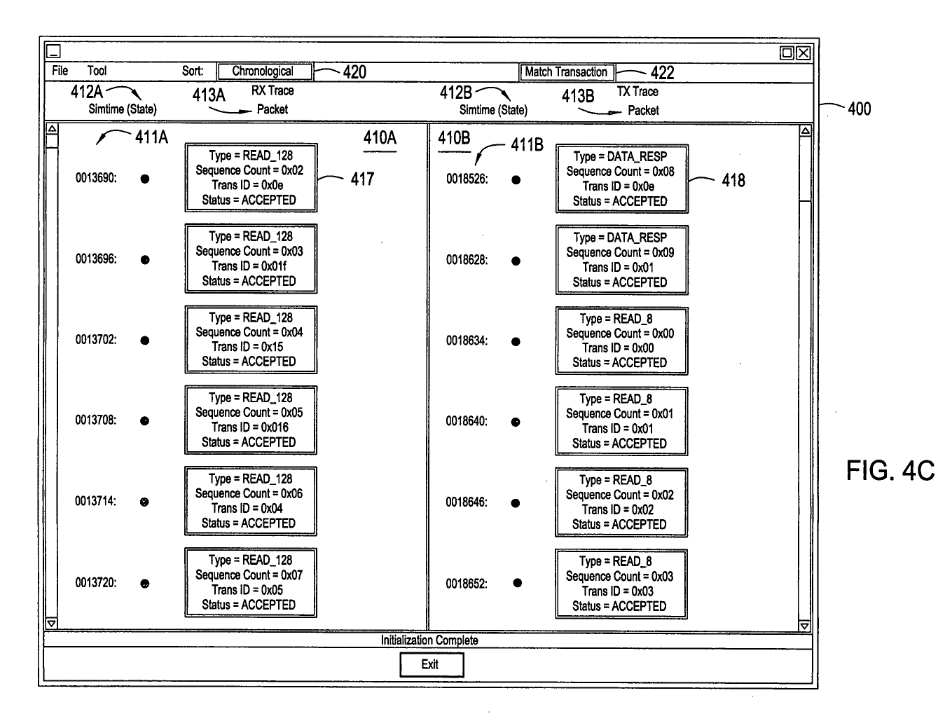

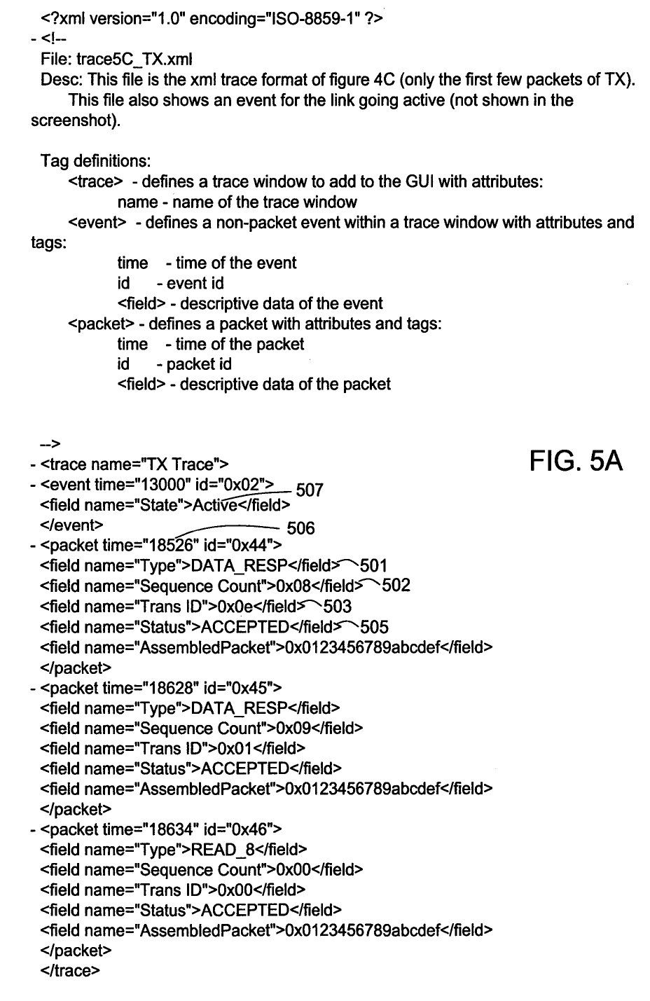

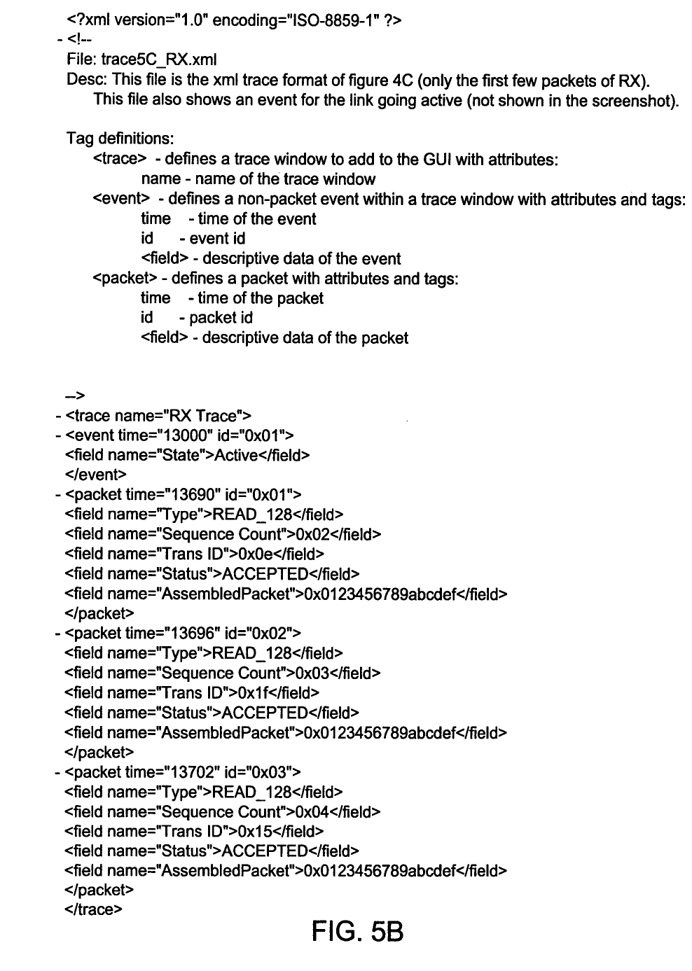

For some embodiments, to facilitate validating bus communications, information in the simulation log 107 may be processed to generate standardized trace output identifying bus events and individual packets. This standardized trace output may be viewed, for example, using available debugger software. For some embodiments, however, the standardized trace output may be presented graphically in a Graphical User Interface (110) tailored to validating bus communications by displaying graphical representations of individual packets 111 and corresponding information. As will be described in greater detail below, with reference to FIGS. 4A-4C, the packets 111 may be displayed in the GUI in separate columns representing a particular device connected to the bus (e.g., one column for packets originating at the GPU and one column for packets originating at the CPU).

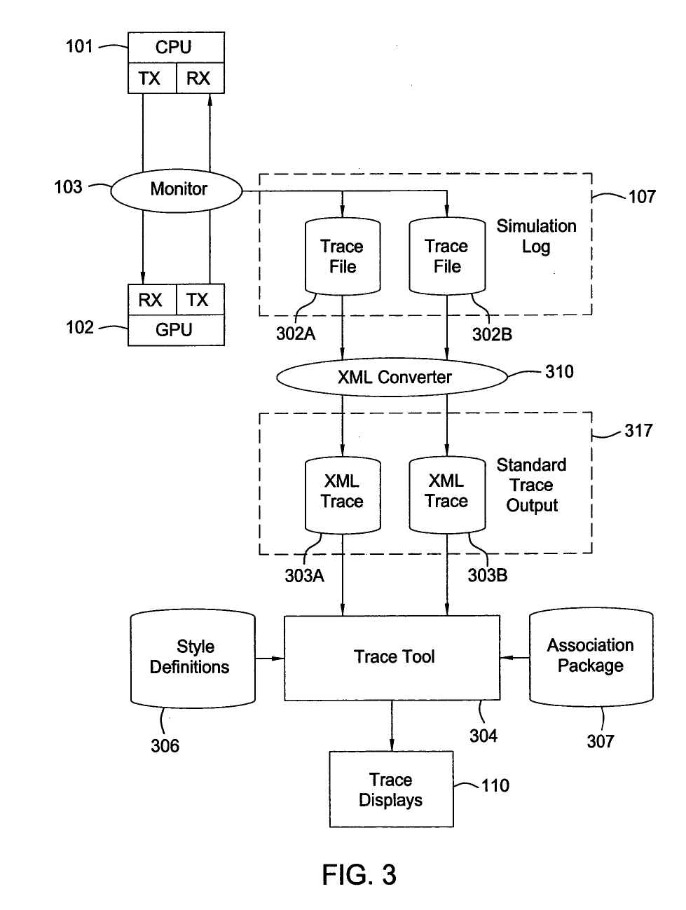

FIG. 2 is a flow diagram of exemplary operations 200 for capturing and displaying bus events in accordance with embodiments of the present invention. The operations may be performed, for example, by components illustrated in FIG. 3, while a specific simulation program designed to emulate normal system operation (and produce typical bus traffic) is being executed. Therefore, to facilitate understanding, FIGS. 2 and 3 may be described together. However, those skilled in the art will recognize that the operations of FIG. 2 may be performed by other components and, further, that the components illustrated in FIG. 3 may be capable of performing other operations.

The operations 200 begin, at step 202, by capturing events on the bus. As previously described, the bus monitor 103 may detect events indicating transactions between the CPU 101 and GPU 102 and store captured events in a simulation log 107. For some embodiments, detected events in the simulation log 107 may be divided into a receive (RX) trace log 302A and a transmit trace log (TX) 302B, for example, from the CPU perspective. Arbitrarily, the RX trace log 302A may contain bus transactions received by the CPU, while the TX trace log 302B may contain bus transactions transmitted by the CPU.

At step 204, information in the simulation log 107 is parsed to generate standardized trace output identifying the captured events. As illustrated, for some embodiments, an XML converter 310 may be configured to generate standardized trace output 317 in extensible Markup Language (XML) format. The XML converter may generate separate XML trace logs 303A and 303B for the CPU and GPU, respectively, corresponding to the trace logs 302A and 302B. XML is just one example of a suitable type standard format in which bus events may be captured.

While the standardized trace output may facilitate the display of captured bus events with a standard debugging tool, such as a waveform viewer, analyzing the displayed bus events (e.g., as bit streams on various bus lines or channels) may still prove a difficult and time consuming task. Therefore, for some embodiments, a tracer tool 304 may be provided to analyze (pre-process) information in the standardized trace output 317 to identify and classify individual packets.

At step 206, packet traffic is graphically displayed. The displayed traffic may include representation of individual packets and corresponding packet types. For example, the tracer tool 304 may employ a classification method to analyze information in the standardized trace output 317 to identify and classify individual packets. For example, a definitions library accessible by the tracer tool 304 may include a set of definitions or templates identifying particular packet types. For example, the definitions may identify fields contained in particular packet types, as well as command codes (e.g., read/write requests, response packets, and the like) identifying the packet type.

The tracer tool 304 may also identify bus events (e.g., a change in bus state to/from inactive, training, or active states) based on captured trace information. Different definitions or event classifications may be provided to correspond to particular packet traffic related to various devices found on the bus, such as bridge chips, memory controllers, and host channel adapters. These definitions may be included in a library with common event codes (e.g., indicating the occurrence of start bits, etc.).

The tracer tool 304 may also associate packets together, based on information in an association component 307. As an example, the association component may include definitions that correlate response packets to request packets (e.g., based on a transaction and/or sequence code). As will be described in greater detail below, such associations may allow packet traffic in a particular bus scenario to be organized directionally (with associated packages aligned), as well as chronologically. Attributes for how packets are represented may be controlled by style definitions 306, which may specify, for example, a display format (colors, etc.) which packet fields to display or hide, and the like. For some embodiments, the style definitions may be user configurable, for example, allowing user-defined style definitions to be applied/overlayed on displayed bus events.

FIGS. 4A-4C illustrate example GUI screens 400 for graphically displaying standardized trace output as packets exchanged between devices (e.g., with RX and TX representing bus events received at, or originating from, one of the devices. Referring first to FIG. 4A, the GUI screen 400 includes two columns 410A and 410B, each column depicting packets driven by a different one of the devices. As illustrated, each packet may be identified by a type (e.g., Read Request, Read Response, Phy Sync, etc.).

Each packet displayed in the columns 410A and 410B may have a set of corresponding information displayed adjacent the packet. Illustratively, a cycle time the packet was detected (SimTime 411), as well as a state of the bus at that time (shown as radio buttons 412), may be displayed adjacent each packet. Exemplary bus states include, but are not limited to inactive (devices not communicating), active (devices communicating), and training states. For some embodiments, radio buttons 412 representing the states may be color coded to allow the user to easily identify the state of the device. For example, the active state may be represented by a green button, the inactive state by a red button, and the training state by a yellow button.

In the training state, one device may repetitively transmit packets of known content (shown as Phy Sync packets 414) to the other device. During training, the other device may adjust internal “deskew” circuitry until it correctly receives the Phy Sync packet. Once one device is trained, it may provide an indication to the other device that it is trained, for example, via a status bit in a transmitted packet. These operations may be repeated to train the other device in a similar manner. This training process may also be repeated as necessary to “retrain” the devices, for example, based on a checksum-based monitored error rate.

As illustrated, various types of information may be displayed with each non-training packet type, such as a transaction ID (TransID) and sequence count. The sequence count may indicate an order in which packets are dispatched and may be used as flow control to limit the number of outstanding (non acknowledged/responded to) packets at any given time. A response to a request may be identified by a packet with the same transaction ID as the request packet and a later sequence count.

Different types of packets may be displayed differently in the GUI to allow the user to easily distinguish between the packet types. For example, in FIG. 4A, a PHY₁₃SYNC packet 414 has a different background color and is of a different size compared to CONTROL packet 415. The data contained in the packets may also be displayed in a clear, concise manner. For example, CONTROL packet consists of fields Type, ReqAckSC, RespAckSC, LS, RS and status. The values in these fields are displayed in the packet. As described above, display attributes for a packet may be defined by corresponding style definitions.

For some embodiments, a user may control exactly what packet information is displayed. For example, the user may normally choose to display only basic information, such as the packet Type, while hiding other fields. During debugging, however, if the user would like to retrieve other packet information that is not displayed, he may be allowed to expand the information displayed, for example, by selecting (e.g., via a mouse click) the packet of interest. FIG. 4B illustrates an example where the user has selected packet 416 to display expanded packet contents that were not displayed in the GUI initially.

As illustrated, this expanded information may include various fields, such as a checksum (CRC), as well as the entire “assembled” packet, from which the detailed fields are extracted. The information may also include a field that indicates whether a particular packet was accepted by a given device. There may be many factors that cause a packet to not be accepted. For example, if a device expects packets in a certain order indicated by a sequence count, the device may reject any packet that is not in the expected order. Such a packet will have to be retransmitted in the correct order. For some embodiments, corrupted packets (e.g., as indicated by a bad checksum) may be displayed in the GUI with the packet type (if recognizable). In some cases, if the packet type is not recognizable, simple raw data for the corrupt packets may be displayed.

The user may also have some control over the organization of packets in the GUI 400. As an example, for some embodiments, the user may organize the display of packets in the device columns in such a way that packets related to the same transaction (e.g., a request and response pair) are aligned in the same row. This is illustrated in FIG. 4C, wherein a read request packet 417 is aligned with the corresponding response packet 418, that may occur at a later time, and after several other intermediate packets have been transmitted. This may be useful because, if the packets are ordered chronologically, it may be difficult to find related packets because several other packets may have been exchanged between the read request and the response. As illustrated, for some embodiments, a user may be able to toggle between chronological and “matched transaction” organization via buttons 420 and 422.

FIGS. 5A and 5B illustrate exemplary XML output that may be captured during simulation and used to create (populate) the GUI screens 400 shown in FIGS. 4A-4C. FIG. 5A illustrates an exemplary XML portion that may be contained in the TX trace portion of standardized trace output 317 (shown in FIG. 3), while FIG. 5B illustrates an exemplary RX trace portion. The information contained therein corresponds packets illustrated in FIGS. 4A-4C.

As illustrated, the trace information may include fields for non-packet events (transition to the Active state and given time), as well as fields for individual packets. Individual packet fields may include packet times, transaction type, transaction id, sequence count, and transaction status, as well as the entire assembled packet. As previously described, additional information may be extracted from the assembled packet.

### CONCLUSION

By converting captured bus events into a standardized format, embodiments of the present invention may enable the display of the bus transactions via a graphical user interface (GUI). As a result, viewing and analyzing the bus transactions when validating communications may be facilitated, which may reduce debug time.

While the foregoing is directed to embodiments of the present invention, other and further embodiments of the invention may be devised without departing from the basic scope thereof, and the scope thereof is determined by the claims that follow.

What is claimed is:

1. A method of validating communications between devices over an interconnect bus, comprising:
monitoring the interconnect bus to detect bus events;
capturing the bus events in a trace log of standardized trace output;
parsing the standardized trace output to identify bus transactions; and
displaying, to a user, at least some of the identified bus transactions in a graphical user interface.

2. The method of claim 1, wherein the standardized trace output comprises extensible Markup Language (XML) code.

3. The method of claim 1, wherein bus transactions comprise the exchange of data packets.

4. The method of claim 3, wherein displaying at least some of the identified bus transactions in the graphical user interface comprises:
displaying a limited portion of information contained in a data packet; and
in response to a request from the user, displaying an additional portion of information contained in the data packet.

5. The method of claim 3, wherein displaying at least some of the identified bus transactions in the graphical user interface comprises:
in response to a request from the user, reorganizing packets graphically represented in the graphical user interface.

6. The method of claim 5, wherein reorganizing packets graphically represented in the graphical user interface comprises aligning request packets with corresponding response packets.

7. The method of claim 3, wherein displaying at least some of the identified bus transactions in the graphical user interface comprises:
graphically representing, with color, a state of a device relative to the bus at the time a corresponding packet was sent.

8. A computer readable medium containing a program for validating communication between devices over an interconnect bus which, when executed, performs operations, comprising:
parsing standardized trace output containing bus events captured during operation of the devices to identify individual packets exchanged between devices over the bus; and
displaying, to a user, representations of at least some of the individual packets in a graphical user interface.

9. The computer readable medium of claim 8, wherein the standardized trace output comprises eXtensible Markup Language (XML) code.

10. The computer readable medium of claim 8, wherein:
parsing standardized trace output comprises classifying each identified packet as being one of a plurality of packet types; and
displaying representations of at least some of the individual packets in the graphical user interface comprises indicating the corresponding packet types.

11. The computer readable medium of claim 10, wherein indicating the corresponding packet types comprises:
displaying different packet types using different discernable display attributes.

12. The computer readable medium of claim 8, wherein:
displaying representations of at least some of the individual packets comprises displaying a limited portion of packet information for a packet.

13. The computer readable medium of claim 12, wherein the operations further comprise:
in response to a request from the user, displaying additional portions of packet information for the packet.

14. The computer readable medium of claim 8, wherein the operations further comprise:
in response to a request from the user, reorganizing packets graphically represented in the graphical user interface.

15. The computer readable medium of claim 14, wherein reorganizing packets graphically represented in the graphical user interface comprises aligning request packets with corresponding response packets.

16. A system for validating communications between devices across an interconnect bus, comprising:
a bus monitor for monitoring traffic across the bus and generating a log of detected bus events;
a converter component for converting the log of detected bus events to generate standardized trace output; and
a graphical user interface for displaying graphical representations of packets exchanged between the devices across the interconnect bus extracted from the standardized trace output.

17. The system of claim 16, wherein the converter component generates standardized trace output as extensible Markup Language format.

18. The system of claim 16, wherein the graphical user interface allows a user to reorganize graphically represented packets by matching request packets with corresponding response packets.

19. The system of claim 16, wherein the graphical user interface allows the user to control the amount of information displayed for one or more of the graphically represented packets.

20. The system of claim 16, wherein the devices comprise a central processing unit (CPU) and a graphics processing unit (GPU).
